(19) United States
(12) Patent Application Publication
(10) Pub. No.: US 2003/0045324 A1
(43) Pub. Date: Mar. 6, 2003

(54) Wireless communication apparatus

(75) Inventors: Shoji Nagumo, Kawasaki-shi (JP); Kengo Onaka, Yokohama-shi (JP); Takashi Ishihara, Tokyo-to (JP); Jin Sato, Sagamihara-shi (JP)

Correspondence Address: Keating & Bennett LLP, Suite 312, 10400 Eaton Place, Fairfax, VA, 22030, US

(73) Assignee: Murata Manufacturing Co., Ltd., Nagaokakyo-shi (JP)

(21) Appl. No.: 10/227,462

(22) Filed: Aug. 26, 2002

(30) Foreign Application Priority Data
Aug. 30, 2001 (JP) 2001-261450

(51) Int. Cl. H04B 1/38; H04M 1/00

(52) U.S. Cl. 455/550; 455/575; 455/90

(57) ABSTRACT

A wireless communication apparatus includes a casing made of a dielectric material. An antenna including a feed element and first and second parasitic elements is provided in the casing. The feed element includes first and second feed radiation plates. A parasitic radiation plate of the first parasitic element is located near the first radiation plate, and a parasitic radiation plate of the second parasitic element is located near the second feed radiation plate. The amount of coupling between the feed element and the first and second parasitic elements is adjusted based on the relative permittivity of the casing. The feed element and the first parasitic element perform multi-resonance in the same frequency band as the resonance frequency of the first feed radiation plate. The feed element and the second parasitic element perform multi-resonance in the same frequency band as the resonance frequency of the second feed radiation plate.

### BACKGROUND OF THE INVENTION

1. Field of the Invention

The present invention relates to wireless communication apparatuses. In particular, the present invention relates to a wireless communication apparatus including a casing provided with a multiband-compatible antenna.

2. Description of the Related Art

Recently, mobile phones including a dual-band antenna have been widely used. Also, wireless communication apparatuses have been commonly used for establishing local area networks (LAN) interconnecting many computers. Mobile phones are required to be compact and lightweight. Also, wireless communication apparatuses used in LANs are required to have a compact antenna because the wireless communication apparatuses are used by being inserted into PCMCIA card slots of computers.

A reverse F-shaped antenna disclosed in Japanese Unexamined Patent Application Publication No. 10-93332 provides an example of the dual-band antenna. In this antenna, a radiation conductive plate is placed above a ground conductive plate with a predetermined space therebetween, and the radiation conductive plate is divided into two parts by a slit so that the radiation conductive plate resonates in two frequency bands. This antenna can be shortened. However, since the radiation conductive plate needs to have an electrical length of one-fourth the wavelength corresponding to the frequency used, the size of the antenna is not suitable for the above-described application. Furthermore, each frequency band has a single resonance characteristic, and thus it is difficult to acquire an adequate bandwidth.

Japanese Unexamined Patent Application Publication No. 2000-151258 discloses an antenna for realizing a broadband miniaturized antenna. This antenna includes a dielectric substrate having a predetermined relative permittivity ∈. A ground electrode is provided on a first major surface of the substrate and two radiation electrodes having one end connected to the ground electrode are provided on a second major surface. One of the radiation electrodes is regarded as a parasitic element and the other radiation electrode is regarded as a feed element by attaching a feed electrode thereto.

In this antenna, the effective line length L of each of the radiation electrodes is defined by λ/4√∈ (λis the wavelength of the frequency used). Therefore, the radiation electrodes can be shortened and the whole antenna can be miniaturized by forming the substrate using a dielectric material having a high relative permittivity ∈. Also, an antenna in which the bandwidth of the resonance frequency is wide can be realized by allowing the feed element and the parasitic element to adequately perform electric-field-coupling and multi-resonance.

Also, Japanese Unexamined Patent Application Publication No. 2001-68917 discloses a compact dual-band antenna. This antenna includes a meandering radiation electrode provided on the surface of a dielectric substrate. The radiation electrode includes two portions having a different meander pitch so that radio waves of two frequency bands can be transmitted and received. In this antenna, too, the relative permittivity ∈ of the substrate is an important factor defining the effective line length L of the radiation electrode.

As described above, an antenna can be miniaturized by using a dielectric substrate. Further, in an antenna having a plurality of frequency bands, each of the frequency bands can be broadened by allowing two resonance frequencies to perform multi-resonance in each frequency band.

Many attempts have been made to miniaturize the antenna, but the antenna itself, one of the important elements of which is a dielectric substrate, occupies a predetermined space on a circuit board of a wireless communication apparatus, and the weight of the substrate cannot be ignored when weight-saving measures are carried out for the wireless communication apparatus. Also, it is difficult to reduce the cost for manufacturing the antenna.

### SUMMARY OF THE INVENTION

In order to overcome the problems described above, preferred embodiments of the present invention provide a wireless communication apparatus in which an antenna is incorporated into a casing.

According to a preferred embodiment of the present invention, a wireless communication apparatus includes a circuit board in which a high-frequency circuit is provided, a casing for accommodating the circuit board, and an antenna disposed inside the casing or on a surface of the casing. The antenna includes a feed element having at least one feed radiation plate and a feed terminal plate for connecting the feed radiation plate to the high-frequency circuit, and at least one parasitic element having a parasitic radiation plate located adjacent to and along the feed radiation plate of the feed element and a ground terminal plate for connecting the parasitic radiation plate to a ground surface of the circuit board.

In this configuration, since the antenna is preferably formed by punching out a conductive plate, the antenna can be produced inexpensively. Further, the feed element and the parasitic element of the antenna are fixed to the inner surface of the casing or are incorporated into the casing, and thus the mounting space for the circuit board increases compared to the case where the antenna is mounted on the circuit board and a space for mounting high-frequency circuit components increases.

Also, the whole casing may be molded by using a casting resin material having a relative permittivity. Even when most of the casing is formed by a non-dielectric material, at least an antenna setting portion is preferably formed of a dielectric material. Therefore, the feed element and the parasitic element can be resonated at frequencies belonging to two or more frequency bands, by using the relative permittivity of the casing, and multi-resonance by the resonance frequency of the feed element and the resonance frequency of the parasitic element can be realized in each frequency band.

When the feed element includes one feed radiation plate, the feed radiation plate preferably has an effective line length so that the feed radiation plate resonates at a frequency of a fundamental resonance and the higher harmonic thereof, for example, a frequency of the second harmonic or the third harmonic. The fundamental resonance and the higher harmonic are adjusted so as to belong to sufficiently separate frequency bands. Herein, when two parasitic elements are located near the feed element, the parasitic radiation plate of one of the parasitic elements preferably has an effective line length having a frequency for performing multi-resonance in the same frequency band as the frequency of the fundamental resonance of the feed element. The parasitic radiation plate of the other parasitic element preferably has an effective line length so that the parasitic radiation plate performs multi-resonance in the same frequency band as the frequency of the higher harmonic of the feed element.

When the feed element includes a plurality of feed radiation plates, each of the feed radiation plates preferably has an effective line length so as to resonate in a different frequency band. A parasitic radiation plate of the parasitic element is disposed near each of the feed radiation plates. The parasitic radiation plate of the parasitic element preferably has an effective line length having a frequency for performing multi-resonance in the same frequency band as the resonance frequency of the paired feed radiation plate of the feed element.

With the above-described arrangement, the parasitic radiation plate of the parasitic element has an effective line length so that the parasitic radiation plate resonates at the frequency of the fundamental resonance and the frequency of the higher harmonic. In this case, when one parasitic element is disposed near the feed element including one feed radiation plate, the frequency of the fundamental of the feed element and the frequency of the fundamental of the parasitic element are adjusted so as to perform multi-resonance in the same frequency band. Also, the frequency of the higher harmonic of the feed element and the frequency of the higher harmonic of the parasitic element are adjusted so as to perform multi-resonance in the same frequency band.

Further, since the antenna is provided in the casing, the amount of electric-field-coupling between the feed element and the parasitic element can be set by using the relative permittivity of the casing. Accordingly, the feed element and the parasitic element can be allowed to perform multi-resonance in each frequency band to which the resonance frequency of the feed element belongs, by adjusting the relative permittivity of the casing, and an antenna in which bandwidth is broadened in each frequency band can be provided.

Also, the antenna does not have to include a substrate, which is quite different from a known antenna, and thus, the weight of the wireless communication apparatus can be significantly reduced. Also, a reflow process is not required for manufacturing the antenna, and thus, the cost for manufacturing the antenna can be reduced.

Further, when the antenna is attached to the wireless communication apparatus, the antenna is placed on the opposite side of the operation surface of the wireless communication apparatus. As a result, radio waves are radiated adequately. Consequently, the gain of the antenna increases and an antenna in which a bandwidth in each frequency band is broadened can be achieved.

The end of the feed radiation plate opposite to the side of the feed terminal plate is regarded as an open end, the end of the parasitic radiation plate opposite to the side of the ground terminal plate is regarded as an open end, a capacitance loading plate is disposed at at least one of the open ends, and a ground plate which is fixed to the casing and which faces the capacitance loading plate is provided.

With this arrangement, an open end capacitance is provided between the capacitance loading plate and the ground plate. Accordingly, by adjusting the open end capacitance considering the relative permittivity of the casing, the resonance frequency of the feed element and/or parasitic element provided with the capacitance loading plate can be adjusted so that the resonance frequency of the feed element and the resonance frequency of the parasitic element can perform multi-resonance easily in the same frequency band.

Also, the multi-resonance matching between the feed element and the parasitic element can be easily obtained by the open end capacitance.

Preferably, the antenna is incorporated into the casing.

In this arrangement, the antenna is incorporated into the casing preferably by insert molding or outsert molding when the casing is molded. Therefore, a mounting mechanism is not required for providing the antenna, and thus the wireless communication apparatus can be easily assembled. Also, the position of the antenna is inevitably separated from the ground surface of the circuit board, and thus the electric field of radiation from the antenna expands and broadband and high gain in the antenna can be achieved.

Preferably, the antenna is disposed on an inner wall of the casing.

With this configuration, since the antenna can be located at an arbitrary position of the casing so that desired characteristics of the antenna can be obtained, the components of the antenna can be aligned with components mounted on the circuit board. Also, when the relative permittivity of the casing is not suitable for realizing multi-resonance of the feed element and the parasitic element, which define the antenna, a dielectric member having a relative permittivity that is higher than that of the casing can be placed between the antenna and the inner wall of the casing.

A portion or the whole of at least one of the feed element and the parasitic element is preferably embedded in the casing, except a feed contact terminal provided in the feed element and a ground contact terminal provided in the parasitic element.

In the above-described configuration, when one of the feed element and the parasitic element is embedded in the casing, the relative permittivity of the casing greatly affects the embedded element compared to the non-embedded element. Thus, the resonance frequency of the embedded element is decreased. Accordingly, the resonance frequency of the embedded element can be adjusted in accordance with the amount of the embedded portion of the feed radiation plate or the parasitic radiation plate.

When both the feed element and the parasitic element are embedded in the casing, the effective relative permittivity of the casing increases in accordance with the amount of the embedded portion. Thus, the electric-field-coupling between the feed element and the parasitic element is strengthened. In other words, the amount of electric-field-coupling in the embedded portion of the feed radiation plate and the parasitic radiation plate is larger than that in the non-embedded portion. Accordingly, by adjusting the amount of the embedded portion of the feed radiation plate or the parasitic radiation plate, a desired matching for achieving multi-resonance of the feed element and the parasitic element can be realized.

Preferably, the relative permittivity of the casing is used to adjust the coupling relationship between the feed element and the parasitic element.

In this arrangement, the relative permittivity of the casing can be changed by changing a type of resin material for casing. A resin material which has a relative permittivity required for allowing the feed element and the parasitic element to perform multi-resonance is selected. When a composite dielectric material is used as the resin material, the relative permittivity of the casing can be adjusted by the type and amount of high dielectric material mixed to a basic resin material.

Herein, the amount of electric-field-coupling between the feed radiation plate of the feed element and the parasitic radiation plate of the parasitic element, and the open end capacitance generated between the parasitic radiation plate of the parasitic element and the ground plate can be set, while the relative permittivity of the casing is a determining factor.

By setting the relative permittivity of the casing, a desired multi-resonance matching of the feed element and the parasitic element can be obtained.

Preferably, at least an antenna setting portion of the casing is molded by using a composite dielectric material.

The composite dielectric material is preferably prepared by mixing a dielectric material having a higher relative permittivity than that of a basic resin material to the basic resin material so as to obtain a desired relative permittivity. Accordingly, the conditions of the antenna including the relative permittivity of the casing can be adequately adjusted by forming the antenna setting portion of the casing by using the composite dielectric material as well as by forming the whole casing by using the composite dielectric material.

By selecting the relative permittivity of the composite dielectric material, the frequency bandwidth of the antenna can be broadened.

The overall portion of the casing in which the feed element and the parasitic element are placed or a portion along the adjacent edges of the feed radiation plate of the feed element and the parasitic radiation plate of the parasitic element is preferably formed by using a dielectric material that has a relative permittivity which is higher than that of the casing.

In this configuration, most of the casing is preferably formed of an inexpensive resin material with which casting can be easily performed. Also, portions for setting the feed element and the parasitic element of the antenna are preferably formed of another resin material or a composite dielectric material having a high relative permittivity. Accordingly, conditions for realizing multi-resonance of the feed element and the parasitic element can be preferably set independently from the relative permittivity of the resin material for forming most of the casing.

Also, only the adjacent portion of the feed radiation plate of the feed element and the parasitic radiation plate of the parasitic plate can preferably be formed of a dielectric material having a high relative permittivity so that only the amount of electric-field-coupling between the feed radiation plate and the parasitic radiation plate increases. By changing the relative permittivity between the feed radiation plate and the parasitic radiation plate, the resonance frequency of the feed element and the parasitic element can be adjusted and the exciting power of the parasitic element can be increased.

Accordingly, the feed element and the parasitic element can be allowed to perform multi-resonance in the same frequency band so as to broaden the bandwidth, regardless of the type of resin material for forming part of the casing.

In the above-described wireless communication apparatus, only the relative permittivity of the portion along the adjacent edges of the feed radiation plate of the feed element and the parasitic radiation plate of the parasitic element is changed. Accordingly, the amount of electric-field-coupling between the feed radiation plate and the parasitic radiation plate can be adjusted so as to surpass the amount of coupling between the other portions of the feed element and the parasitic element.

A dielectric member having a relative permittivity that is higher than that of the casing is preferably disposed between the inner wall of the casing, the feed radiation plate of the feed element, and the parasitic radiation plate of the parasitic element.

The dielectric member is disposed between the feed radiation plate and the parasitic radiation plate of the antenna and the inner wall of the casing when the antenna is fixed to the inner wall of the casing. The amount of electric-field-coupling between the feed radiation plate and the parasitic radiation plate is adjusted by the dielectric member so that the feed element and the parasitic element can perform multi-resonance.

Accordingly, even when the amount of electric-field-coupling between the feed radiation plate and the parasitic radiation plate cannot be adequately adjusted by the relative permittivity of the casing, a desired multi-resonance matching between the feed element and the parasitic element can be obtained.

Preferably, the feed contact terminal and the ground contact terminal are resilient, the resilient feed contact terminal is provided in the feed radiation plate, and the resilient ground contact terminal is provided in the parasitic radiation plate.

With this configuration, when a portion of the casing accommodating the circuit board and a portion of the casing accommodating the antenna are combined, the feed contact terminal of the feed radiation plate contacts a feed contact land provided on the circuit board and the ground contact terminal of the parasitic radiation plate contacts a ground contact land provided on the circuit board.

Because of the resilient contact terminals, the connection between the antenna and the high-frequency circuit can be kept stably even when vibration or other forces are applied to the wireless communication apparatus.

Preferably, the casing includes a first casing and a second casing. The circuit board provided with a feed contact land and a ground contact land is disposed in the first casing, and the antenna including the feed contact terminal and the ground contact terminal is disposed in the second casing. The feed contact terminal contacts the feed contact land so as to be energized and the ground contact terminal contacts the ground contact land so as to be energized when the first and second casings are combined.

With this configuration, setting of the antenna and setting of the circuit board can be performed separately, and thus, the wireless communication apparatus can be easily assembled. Also, the feed contact terminal and the ground contact terminal of the antenna contact the feed contact land and the ground contact land of the circuit board, respectively, so as to be energized when the first and second casings are combined. Therefore, leads are not required to be provided and soldering is not required, and thus workability can be improved.

Other features, elements, characteristics and advantages of the present invention will become more apparent from the following detailed description of the present invention with reference to the attached drawings.

### BRIEF DESCRIPTION OF THE DRAWINGS

FIG. 1 is a perspective view showing a schematic inside configuration of a wireless communication apparatus according to a preferred embodiment of the present invention by dividing a casing;

FIG. 2 is a cross-sectional view of the critical portion of the wireless communication apparatus according to a preferred embodiment of the present invention;

FIG. 3 is a perspective view showing a preferred embodiment of an antenna included in the wireless communication apparatus shown in FIG. 1;

FIG. 4 shows a frequency characteristic of return loss in the antenna shown in FIG. 3;

FIG. 5 is a schematic sectional view for illustrating another configuration of an open end capacitance formation portion in the antenna shown in FIG. 3;

FIG. 6 is a perspective view showing another preferred embodiment of the antenna included in the wireless communication apparatus shown in FIG. 1;

FIG. 7 shows a frequency characteristic of return loss in the antenna shown in FIG. 6;

FIG. 8 is a perspective view showing another preferred embodiment of antenna setting in the wireless communication apparatus;

FIG. 9 is a perspective view showing a further preferred embodiment of the antenna included in the wireless communication apparatus shown in FIG. 1;

FIG. 10 is a perspective view showing an additional preferred embodiment of the antenna included in the wireless communication apparatus shown in FIG. 1;

FIG. 11 is a plan view showing the inner configuration of the casing in which part of the antenna is embedded in the casing;

FIG. 12 is a cross-sectional view of the critical portion of the configuration shown in FIG. 11;

FIG. 13 is a perspective view showing a preferred embodiment in which a material for forming an antenna setting portion of the casing is changed;

FIG. 14 is a cross-sectional view of the critical portion of the configuration shown in FIG. 13;

FIG. 15 is a plan view showing the inner configuration in which a portion of the antenna is formed by using a dielectric material that is different from that for the casing;

FIG. 16 is cross-sectional view of the critical portion of the configuration shown in FIG. 15;

FIG. 17 is a cross-sectional view of the critical portion showing a preferred embodiment of antenna setting in the wireless communication apparatus; and

FIG. 18 is a plan view showing another preferred embodiment of the antenna included in the wireless communication apparatus.

### DETAILED DESCRIPTION OF PREFERRED EMBODIMENTS

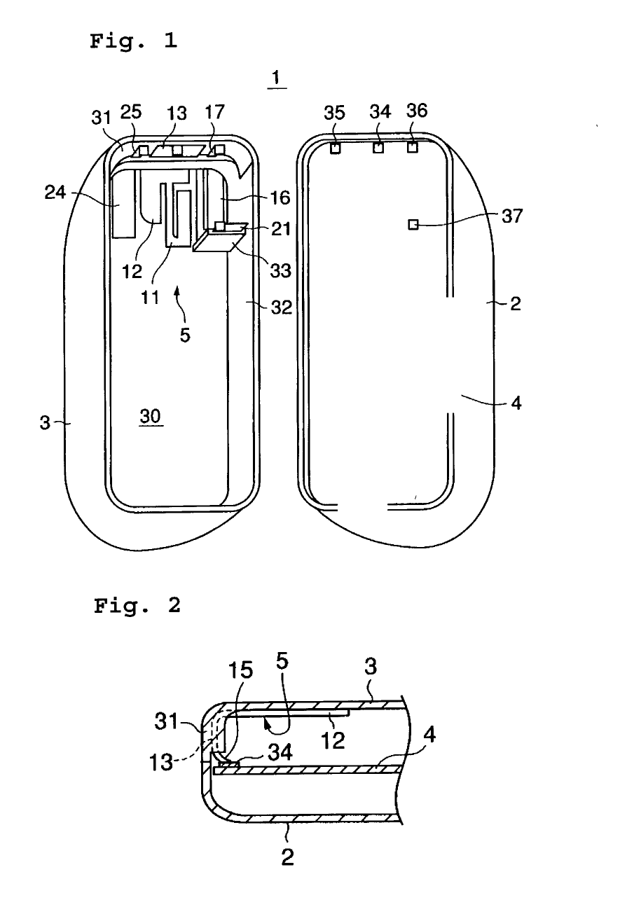

Hereinafter, preferred embodiments of the present invention will be described with reference to the drawings. FIGS. 1 to 3 show a preferred embodiment of a mobile phone defining as a wireless communication apparatus according to the present invention.

In FIG. 1, a mobile phone 1 can be held by one hand, and includes front and back casings 2 and 3 preferably made of a synthetic resin. The right side of the figure shows an operation side of the mobile phone 1 and a circuit board 4 is exposed inside the casing 2. High-frequency circuit components and so on covered by a shielding case (not shown) are mounted on the circuit board 4. Also, a keypad, a liquid crystal panel, a microphone, a speaker, and so on are provided on the operation surface (not shown).

On the left side of the figure, the back casing 3 of the mobile phone 1 is shown. A battery container (not shown) is provided inside the casing 3. Also, an antenna 5, having a configuration that will be described later, is provided in the casing 3 by insert molding.

As shown in FIG. 3, the antenna 5 includes a feed element 6 and parasitic elements 7 and 8. Each of the feed element 6 and the parasitic elements 7 and 8 is preferably formed by punching out a thin conductive plate such as copper, copper alloy, or aluminum, or other suitable material. The feed element 6 includes two feed radiation plates 11 and 12 formed by dividing a common radiation plate 9 by a slit 10 and a feed terminal plate 13 which is substantially perpendicular to the common radiation plate 9.

The feed radiation plate 11 has a slit 14 at the center thereof. The length of the feed radiation plate 11, that is, the length from the common radiation plate 9 to an open end 11a preferably has an effective line length such that the feed radiation plate 11 resonates at a frequency f1 of about 900 MHz, taking the relative permittivity of the casing 3 into consideration. On the other hand, in the feed radiation plate 12, the length to an open end 12a preferably has an effective line length which is shorter than that of the feed radiation plate 11, taking the relative permittivity of the casing 3 into consideration. That is, the effective line length of the feed radiation plate 12 is set so that the feed radiation plate 12 resonates at a frequency f2, which belongs to a frequency band that is different from the frequency f1, for example, a frequency of about 1800 MHz.

The feed terminal plate 13 preferably has substantially the same width as that of the common radiation plate 9. A feed contact terminal 15, which electrically contacts a feed contact land (described later), is provided at the edge thereof opposite to the common radiation plate 9. The feed contact terminal 15 is slightly resilient so that it can preferably contact the feed contact land.

The parasitic element 7 includes a parasitic radiation plate 16, a strip-like ground terminal plate 17 provided at one end in the longitudinal direction of the parasitic radiation plate 16, the ground terminal plate 17 being substantially perpendicular to the parasitic radiation plate 16, and a capacitance loading plate 18 which is substantially perpendicular to the parasitic radiation plate 16 and which extends in the same direction as the ground terminal plate 17. The capacitance loading plate 18 is provided at the other end in the longitudinal direction of the parasitic radiation plate 16.

The width of the ground terminal plate 17 is narrower than that of the parasitic radiation plate 16. A resilient ground contact terminal 19 having the same dimension as that of the feed contact terminal 15 of the feed element 6 is provided at the end of the ground terminal plate 17. Also, a slit 20, which is formed by slitting the parasitic radiation plate 16 longitudinally from the end provided with the ground terminal plate 17, is provided at the center of the parasitic radiation plate 16. The slit 20 is hook-shaped. The length of the parasitic radiation plate 16, that is, the length from the ground terminal plate 17 to an open end 16a preferably has an effective line length so that the parasitic radiation plate 16 resonates at a frequency f3, which is a little lower than the resonance frequency f1 of the feed radiation plate 11, taking the relative permittivity of the casing 3 into consideration.

Since a deepest portion 20a of the slit 20 is bent, the parasitic radiation plate 16 resonates at a frequency f5, which is a harmonic resonance of the resonance frequency f3 of the parasitic radiation plate 16, based on the effective line length from the deepest portion 20a of the slit 20 to the open end 16a. That is, the parasitic element 7 functions as a resonator having an electrical length in which the parasitic element 7 resonates at the frequency f3 (fundamental) and an electrical length in which the parasitic element 7 resonates at the harmonic f5. The resonance frequency f5 can be adjusted according to the shape of the slit 20, and is set to be a frequency which is a little higher than the resonance frequency f2 of the feed radiation plate 12.

A ground plate 21, which is preferably formed by punching out a conductive plate independently from the parasitic element 7, is arranged such that the ground plate 21 faces the capacitance loading plate 18 of the parasitic element 7. The ground plate 21 is flush with the capacitance loading plate 18 with a gap therebetween. An open end capacitance is provided between the ground plate 21 and the capacitance loading plate 18. Also, the ground plate 21 is provided with a resilient ground contact terminal 22, which is disposed at the end thereof opposite to the capacitance loading plate 18.

The other parasitic element 8 includes a parasitic radiation plate 24 and a strip-like ground terminal plate 25, which is provided at one end in the longitudinal direction of the parasitic radiation plate 24 and which is substantially perpendicular to the parasitic radiation plate 24. The width of the ground terminal plate 25 is narrower than that of the parasitic radiation plate 24. Also, a resilient ground contact terminal 26 is disposed at the end of the ground terminal plate 25, the dimension of the ground contact terminal 26 preferably being substantially the same as that of the ground contact terminal 19.

The parasitic radiation plate 24 has an effective line length which is set by taking the relative permittivity of the casing 3 into consideration. The effective line length is substantially equal to the effective line length of the feed radiation plate 12 of the feed element 6. Herein, the parasitic radiation plate 24 is set so as to resonate at a frequency f4, which is a little lower than the resonance frequency f2 of the feed radiation plate 12.

The antenna 5 having the above-described configuration is inserted into a metallic mold when the casing 3 is molded with a synthetic resin, and is incorporated with the casing 3 by injecting a synthetic resin into the metallic mold. At this time, in the metallic mold, the feed terminal plate 13 of the feed element 6 and the ground terminal plates 17 and 25 of the parasitic elements 7 and 8 are aligned on the same side. Also, with the feed element 6 being the center, the parasitic radiation plate 16 of the parasitic element 7 is placed on the side of the feed radiation plate 11, the parasitic radiation plate 16 being substantially parallel with the feed radiation plate 11 with a predetermined space therebetween, and the parasitic radiation plate 24 of the parasitic element 8 is placed on the side of the feed radiation plate 12, the parasitic radiation plate 24 being substantially parallel with the feed radiation plate 12 with a predetermined space therebetween. Further, the ground plate 21 is arranged so as to face the capacitance loading plate 18.

By forming the casing 3, the feed radiation plates 11 and 12 of the feed element 6 and the parasitic radiation plates 16 and 24 of the parasitic elements 7 and 8, which define the antenna 5, are arranged so as to be exposed at the surface of a bottom wall 30 of the casing 3. The capacitance loading plate 18 of the parasitic element 7 is exposed from a partition 33, which is provided at rightangles with the bottom wall 30 and a longitudinal side wall 32 of the casing 3. The feed terminal plate 13 and the ground terminal plates 17 and 25 are embedded in a shorter side wall 31 of the casing 3. Also, the ground plate 21 is arranged so as to be exposed in the surface of the partition 33 so that the ground plate 21 faces the capacitance loading plate 18.

On the other hand, the circuit board 4 accommodated in the casing 2 is provided with a feed contact land 34 at the position corresponding to the feed contact terminal 15 of the feed element 6. Also, ground contact lands 35, 36, and 37 are provided at the positions corresponding to the ground contact terminals 19 and 26 of the parasitic elements 7 and 8 and the ground contact terminal 22 of the ground plate 21, respectively. The feed contact land 34 also functions as an input terminal of a high-frequency circuit, which is formed in the circuit board 4, for performing transmission/reception of radio frequency. The ground contact lands 35, 36, and 37 are connected to a ground conductor in the circuit board 4 so as to be grounded.

In this configuration, by combining the casings 2 and 3, the feed contact terminal 15 contacts the feed contact land 34 so as to be energized. Also, the ground contact terminals 19, 26, and 22 contact the ground contact lands 35, 36, and 37, respectively, so as to be energized. When the power of the wireless communication apparatus is turned on and then the feed element 6 is excited by a signal power supplied from the high-frequency circuit of the circuit board 4, the feed element 6 resonates at the frequency f1 defined by the effective line length of the feed radiation plate 11 and at the frequency f2 defined by the effective line length of the feed radiation plate 12.

The two resonance frequencies f1 and f2 belong to different frequency bands. That is, for example, the frequency f1 belongs to a frequency band of about 900 MHz and the frequency f2 belongs to a frequency band of about 1800 MHz, and these frequency bands are sufficiently separated from each other. The width of the slit 10 between the feed radiation plates 11 and 12 is set so as to reduce a mutual interference between the feed radiation plates 11 and 12.

Also, when the feed element 6 is excited, the parasitic elements 7 and 8 are also excited by being coupled to the feed element 6 in an electromagnetic field. More specifically, the feed element 6 and the parasitic element 7 are excited mainly by electric-field-coupling via the capacitance formed between the parasitic radiation plate 16 and the feed radiation plate 11 and by magnetic-field-coupling between the ground terminal plate 17 and the feed terminal plate 13. Likewise, the feed element 6 and the parasitic element 8 are excited mainly by electric-field-coupling via the capacitance generated between the parasitic radiation plate 24 and the feed radiation plate 12 and by magnetic-field-coupling between the ground terminal plate 25 and the feed terminal plate 13.

The electric-field-coupling between the parasitic radiation plate 16 and the feed radiation plate 11 is adjusted by changing the space between the parasitic radiation plate 16 and the feed radiation plate 11 and by changing the relative permittivity of the casing 3 between the parasitic radiation plate 16 and the feed radiation plate 11. During adjustment, the electric-field-coupling is weakened by increasing the space between the parasitic radiation plate 16 and the feed radiation plate 11 or by reducing the relative permittivity of the casing 3. Accordingly, the effective line length of the parasitic radiation plate 16 and the feed radiation plate 11 which affects the dimension of the antenna 5, selection of synthetic resin material for the casing 3, and the space in the casing 3 to which the antenna 5 is placed, should be considered.

Also, the electric-field-coupling between the parasitic radiation plate 24 and the feed radiation plate 12 is adjusted by changing the space between the parasitic radiation plate 24 and the feed radiation plate 12 and by changing the relative permittivity of the casing 3 between the parasitic radiation plate 24 and the feed radiation plate 12.

The electric-field-coupling between the feed element 6 and the parasitic elements 7 and 8 becomes stronger toward the open end side of the feed radiation plates 11 and 12 and the parasitic radiation plates 16 and 24. Accordingly, an open end capacitance is generated between the capacitance loading plate 18 and the ground plate 21 provided at the open end side of the parasitic radiation plate 16. The value of the open end capacitance is affected by the relative permittivity of the casing 3 and is defined mainly by the space between the capacitance loading plate 18 and the ground plate 21 and the facing area of the capacitance loading plate 18 and the ground plate 21. The two resonance frequencies f3 and f5 of the parasitic element 7 are adjusted by changing the open end capacitance.

Further, the magnetic-field-coupling between the feed element 6 and the parasitic elements 7 and 8 is adjusted by changing the spaces between the feed terminal plate 13 and the ground terminal plates 17 and 25. For example, by reducing the width of the feed terminal plate 13, the amount of the magnetic-field-coupling can be changed without changing the amount of the electric-field-coupling between the feed element 6 and the parasitic elements 7 and 8.

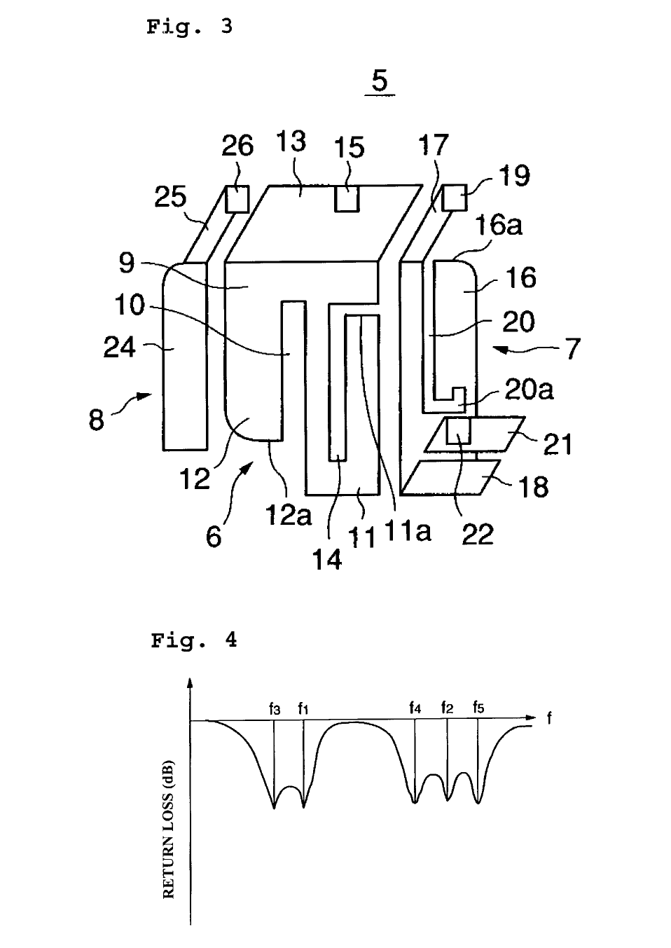

With this arrangement, among the resonance frequencies f3 and f5 in the parasitic radiation plate 16 of the parasitic element 7, the resonance frequency f3 is in the vicinity of and coexists with the resonance frequency f1 of the feed radiation plate 11, in the frequency band to which the resonance frequency f1 of the feed radiation plate 11 belongs, as shown in FIG. 4. Accordingly, the feed element 6 and the parasitic element 7 perform multi-resonance in a frequency band of, for example, about 900 MHz.

Likewise, the resonance frequency f4 in the parasitic radiation plate 24 of the parasitic element 8 and the harmonic f5 in the parasitic element 7 are in the vicinity of and coexist with the resonance frequency f2 of the feed radiation plate 12, in the frequency band to which the resonance frequency f2 of the feed radiation plate 12 of the feed element 6 belongs. The feed element 6 and the parasitic elements 7 and 8 perform multi-resonance in a frequency band of, for example, about 1800 MHz. By the multi-resonance of the three frequencies f2, f4, and f5, the bandwidth of the frequency band to which the resonance frequency f2 belongs is greatly extended compared to the bandwidth of the frequency band to which the resonance frequency f1 of the feed element 6 belongs.

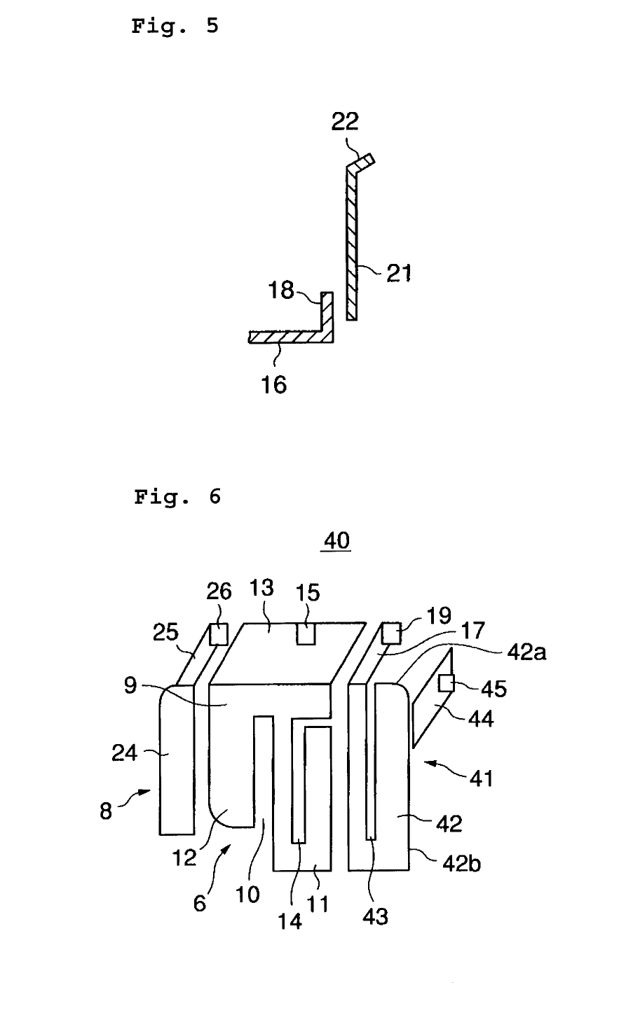

The edges of the capacitance loading plate 18 and the ground plate 21 provided in the parasitic radiation plate 16 preferably face each other in FIG. 3. Alternatively, the capacitance loading plate 18 and the ground plate 21 may be arranged so that side surfaces thereof face each other, as shown in FIG. 5. For example, the capacitance loading plate 18 may be arranged on the surface of the partition 33 and the ground plate 21 may be embedded in the partition 33. With this arrangement, the relative permittivity of the casing 3 exists between the capacitance loading plate 18 and the ground plate 21, and thus the open end capacitance can be increased. The capacitance loading plate 18 and the ground plate 21 are disposed also in the feed radiation plate 11 of the feed element 6 as required.

FIGS. 6 to 10 show a preferred embodiment in which the configuration of the antenna 5 is modified from that in the foregoing preferred embodiment. Elements which are the same as those in the foregoing preferred embodiment are denoted by the same reference numerals and a duplicate description will be omitted.

In FIG. 6, a parasitic element 41 includes a parasitic radiation plate 42 and the strip-like ground terminal plate 17 provided at one end in the longitudinal direction of the parasitic radiation plate 42, the ground terminal plate 17 being substantially perpendicular to the parasitic radiation plate 42. A slit 43 is formed at the center of the parasitic radiation plate 42, the slit 43 being extended longitudinally from the side of the ground terminal plate 17. Also, a ground plate 44 provided with a ground contact terminal 45 is placed near an open end 42a of the parasitic radiation plate 42. An open end capacitance is generated between the ground plate 44 and an open edge 42b of the parasitic radiation plate 42. The ground plate 44 may be located at another position along the open edge 42b of the parasitic radiation plate 42 as required.

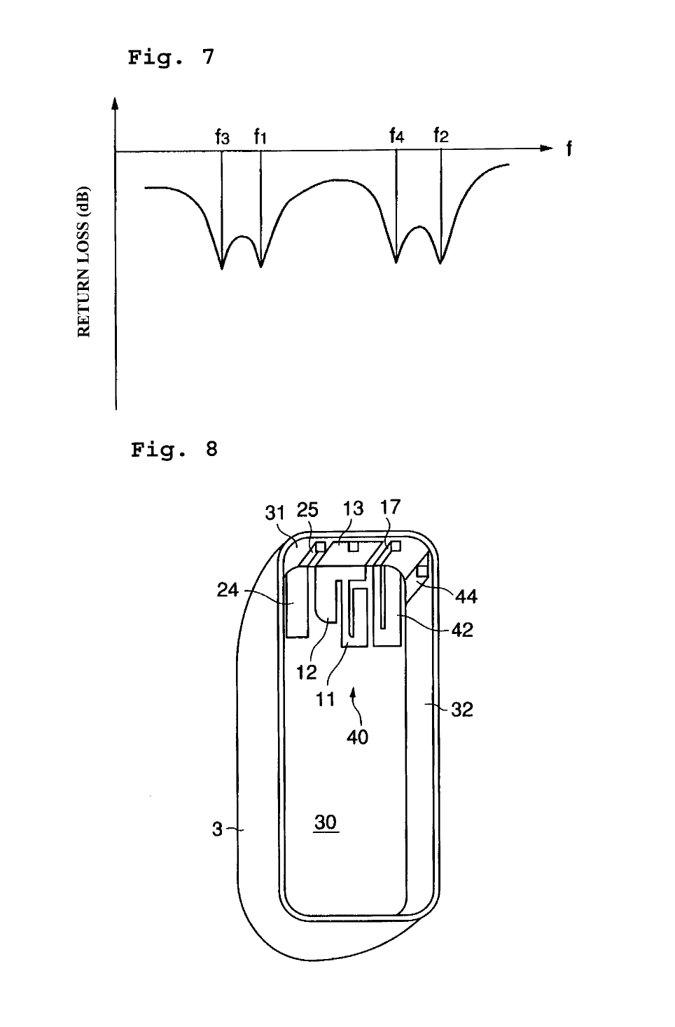

The length of the parasitic radiation plate 42, that is, the length from the ground terminal plate 17 to the open end 42a preferably has an effective line length so that the parasitic radiation plate 42 resonates at the frequency f3. Herein, the harmonic resonance of the frequency f3 in the foregoing embodiment is not taken into consideration. Accordingly, as shown in FIG. 7, the resonance frequency f3 of the parasitic radiation plate 42 and the resonance frequency f1 of the feed element 6 perform multi-resonance in the frequency band to which the resonance frequency f1 belongs, and the resonance frequency f4 of the parasitic radiation plate 24 and the resonance frequency f2 of the feed element 6 perform multi-resonance in the frequency band to which the resonance frequency f2 belongs.

An antenna 40 having the above-described configuration is placed in a metallic mold when the casing 3 is molded with a resin material, and is incorporated into the casing 3 by outsert molding, as shown in FIG. 8. That is, the feed radiation plates 11 and 12, the common radiation plate 9, and the parasitic radiation plates 24 and 42 are exposed at the surface of the bottom wall 30 of the casing 3. Also, the feed terminal plate 13 and the ground terminal plates 17 and 25 are exposed at the surface of the shorter side wall 31 of the casing 3. Further, the ground plate 44 is exposed at the surface of the longitudinal wall 32 of the casing 3.

Referring to FIG. 9, a feed element 47 of an antenna 46 includes a feed radiation plate 48 including a plurality of slits 50 and a strip-like feed terminal plate 49 disposed at one end in the longitudinal direction of the feed radiation plate 48, the feed terminal plate 49 being substantially perpendicular to the feed radiation plate 48. The effective line length of the feed radiation plate 48 is set so that the feed radiation plate 48 resonates at the frequency f1. Further, by providing the slits 50, which extend horizontally, in the feed radiation plate 48, the feed element 47 has an electrical length for exciting at the harmonic of the resonance frequency f1, for example, the frequency f2 of the second harmonic or the third harmonic.

With this configuration, the feed element 47 resonates at the frequency f1 which belongs to the same frequency band as the resonance frequency f3 of the parasitic element 41 so that the feed element 47 and the parasitic element 41 perform multi-resonance. Also, the harmonic of the feed element 47 can be set to the frequency f2 which belongs to the same frequency band as the resonance frequency f4 of the parasitic element 24. The feed element 47 is set so as to perform multi-resonance with the parasitic element 24 in the harmonic.

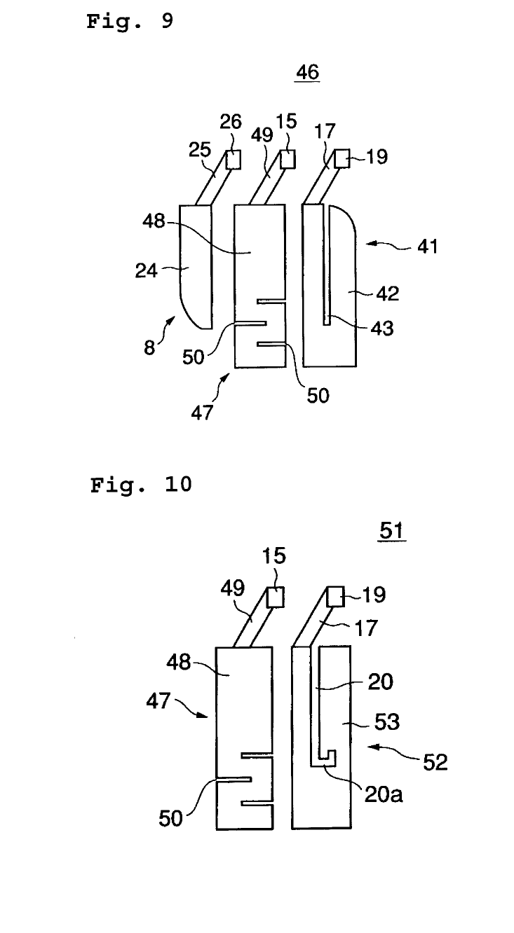

As shown in FIG. 10, an antenna 51 may include a feed element and a parasitic element having an electrical length for resonating at the frequency of the fundamental and the frequency of the harmonic. In this preferred embodiment, the feed element has the same configuration as the feed element 47 in FIG. 9, and resonates at the frequency f1 of the fundamental and the frequency f2 of the harmonic. The parasitic element includes a parasitic radiation plate 53. The parasitic radiation plate 53 includes a slit 20 at the center thereof, as in the parasitic element 7 in FIG. 3. The parasitic element resonates at the frequency f3 of the fundamental and the frequency f4 of the harmonic.

The resonance frequencies of the feed element 47 and the parasitic element 52 are set so that the resonance frequency f1 of the feed element 47 and the resonance frequency f3 of the parasitic element 52 perform multi-resonance in the same frequency band, and such that the resonance frequency f2 of the feed element 47 and the resonance frequency f4 of the parasitic element 52 perform multi-resonance in the same frequency band. The parasitic element 52 may be provided with the ground plate 44 as shown in FIG. 6 as required so as to adjust the resonance frequency.

FIGS. 11 to 17 show preferred embodiments in which the configuration of the casing side is modified from that in the foregoing preferred embodiments. Elements which are the same as those in the foregoing preferred embodiments are denoted by the same reference numerals and a duplicate description will be omitted.

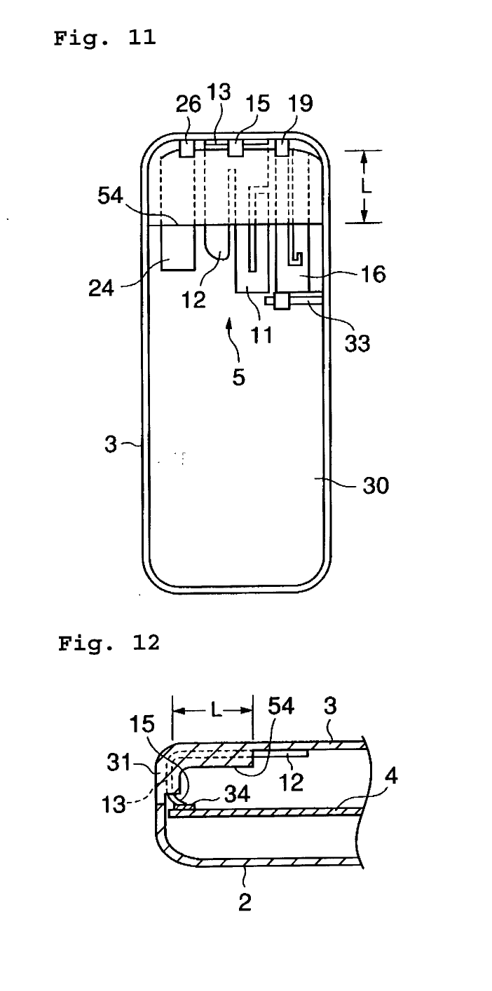

As shown in FIGS. 11 and 12, the antenna 5 is arranged such that a portion of the radiation plates 11, 12, 16, and 24 is embedded in the casing 3. More specifically, in the casing 3, the portions of a predetermined length L of the feed radiation plates 11 and 12 of the feed element 6 and the parasitic radiation plates 16 and 24 of the parasitic elements 7 and 8 are embedded in the bottom wall 30, as shown in FIG. 11. The effective relative permittivity of the casing 3 greatly affects an embedded portion 54, that is, the embedded portions of the feed radiation plates 11 and 12 and the parasitic radiation plates 16 and 24, compared to the non-embedded portion.

Herein, the amount of electric-field-coupling between the feed radiation plates 11 and 12 and the parasitic radiation plates 16 and 24 in the embedded portion 54 in the casing 3 is larger than the case where the feed radiation plates 11 and 12 and the parasitic radiation plates 16 and 24 are not embedded in the casing 3. Accordingly, the resonance frequency of the feed element 6 and the parasitic elements 7 and 8 can be adjusted in accordance with the length L of the embedded portion 54 and multi-resonance matching between the feed element 6 and the parasitic elements 7 and 8 can be obtained in the same frequency band. If the entirety of the feed radiation plates 11 and 12 and the parasitic radiation plates 16 and 24 are embedded in the bottom wall 30, the effect of the effective relative permittivity of the casing 3 is maximized.

Alternatively, only the feed element 6 or the parasitic elements 7 and 8 may be embedded in the bottom wall 30 of the casing 3. In this case, the effective relative permittivity for the embedded element is increased, and thus the resonance frequency of the embedded element can be adjusted in accordance with the length L of the embedded portion 54. Also, only one of the parasitic elements 7 and 8 may be embedded.

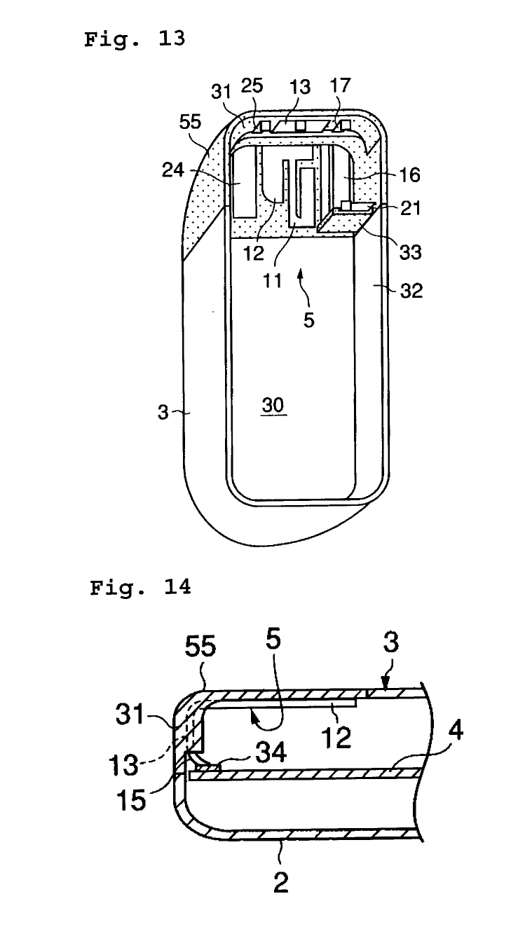

Also, in the preferred embodiment shown in FIG. 1, the relative permittivity of the casing 3 may be too small due to the configuration of the antenna 5. In this case, as shown in FIGS. 13 and 14, an antenna setting portion 55 in the casing 3 is preferably molded by using a casting material whose relative permittivity is higher than that of the remainder of the casing 3, for example, an urea resin material or a composite dielectric material. The remainder of the casing 3 is preferably molded by using a resin material for basic casting.

By molding the antenna setting portion 55 of the casing 3 by using a different casting resin material from the resin material for the basic casting, a suitable relative permittivity for the antenna 5 can be obtained. As the composite dielectric material, a casting material prepared by mixing ceramics powder having a relative permittivity of about 6 to about 30 to the casting resin material can be preferably used. Incidentally, the overall casing 3 can be molded by using the composite dielectric material.

With the above-described configuration, a portion of the casing 3 may have a high relative permittivity, without changing the form of the casing 3. By increasing the relative permittivity of the antenna setting portion 55 in the casing 3, the amount of electric-field-coupling between the feed element 6 and the parasitic elements 7 and 8 and the open end capacitance between the capacitance loading plate 18 and the ground plate 21 increase. Therefore, by appropriately setting the relative permittivity of the composite dielectric material, the amount of coupling between the feed element 6 and the parasitic elements 7 and 8 can be freely set. Accordingly, the multi-resonance matching between the feed element 6 and the parasitic elements 7 and 8 can be easily adjusted.

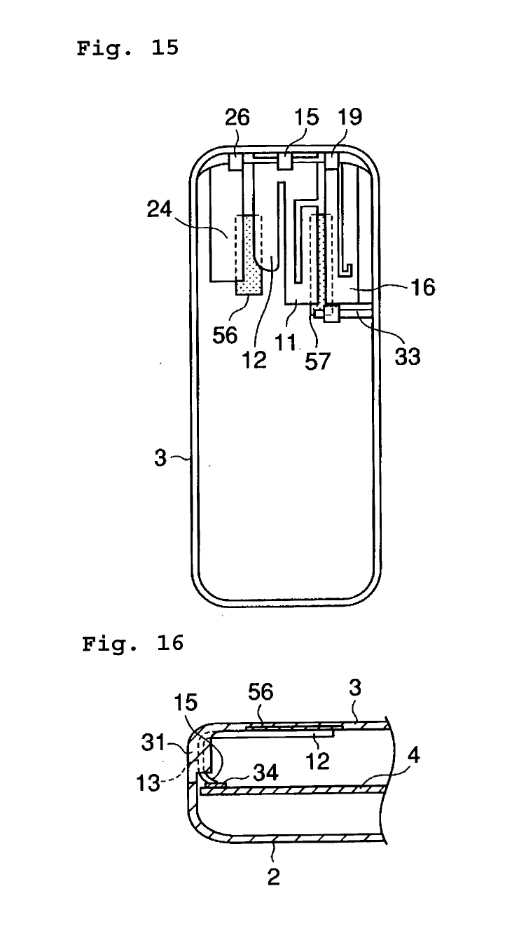

The electric-field-coupling between the feed element 6 and the parasitic elements 7 and 8 is caused mainly between the feed radiation plates 11 and 12 and the parasitic radiation plates 16 and 24. For this reason, as shown in FIGS. 15 and 16, thin high-relative-permittivity portions 56 and 57, which has a relative permittivity higher than that of the resin material for basic casting of the casing 3, are provided at the portions along edges where the feed element 6 and the parasitic elements 7 and 8 adjoin each other. In addition, the overall casing 3 including the high-relative-permittivity portions 56 and 57 is molded by using a resin material for basic casting.

In this configuration, the amount of electric-field-coupling between the feed radiation panels 11 and 12 of the feed element 6 and the open end capacitance between the capacitance loading plate 18 and the ground plate 21 are kept to have a low relative permittivity of the casting resin material. On the other hand, the portions between the feed radiation plates 11 and 12 and the parasitic radiation plates 16 and 24 have a high relative permittivity and the amount of electric-field-coupling increases. Therefore, by selecting the relative permittivity of the resin material for casting the high-relative-permittivity portions 56 and 57 between the feed radiation plates 11 and 12 and the parasitic radiation plates 16 and 24, a desired multi-resonance matching can be obtained.

In the above-described preferred embodiments, the antenna 5 is provided in the casing 3 by insert molding or outsert molding. Alternatively, after the casing 3 is molded by using a casting resin material, the feed element 6, the parasitic elements 7 and 8, and the ground plate 21, which are preferably formed by punching out a conductive plate, may be provided on the inner wall of the casing 3, that is, on the bottom wall 30, the shorter side wall 31, and the longitudinal side wall 32.

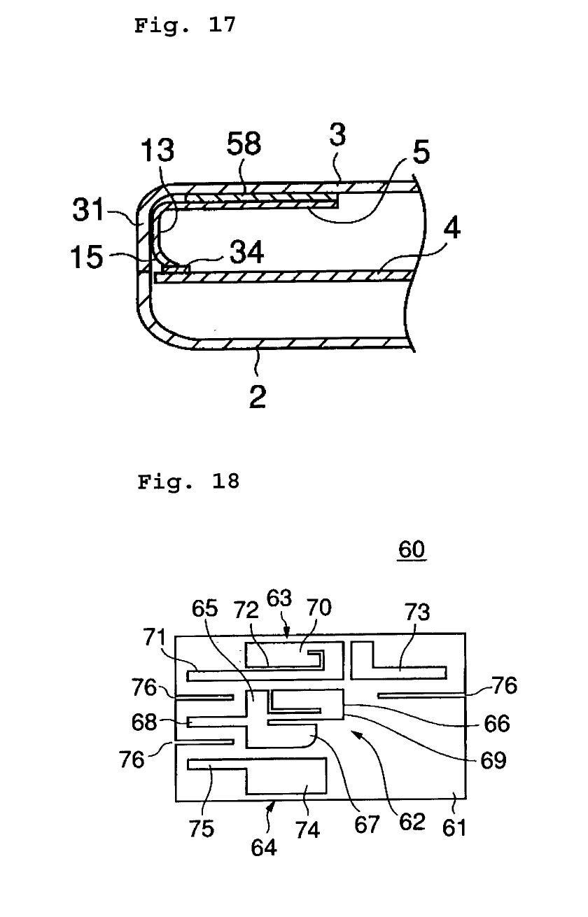

In this configuration, if the relative permittivity of the casing 3 is low and the multi-resonance matching between the feed element 6 and the parasitic elements 7 and 8 cannot be obtained, a dielectric sheet 58 having a relative permittivity that is higher that that of the casing 3 is placed between the inner wall of the casing 3 and the radiation plates of the antenna 5, that is, the feed radiation plates 11 and 12 and the parasitic radiation plates 16 and 24, as shown in FIG. 17. The dielectric sheet 58 may be attached to the feed radiation plates 11 and 12 and the parasitic radiation plates 16 and 24 of the antenna 5, or may be attached to the inner wall of the casing 3. As the dielectric sheet 58, a sheet formed with the above-described composite dielectric material can be used.

FIG. 18 shows another preferred embodiment of an antenna used for the wireless communication apparatus of the present invention. An antenna 60 is preferably formed by etching a thin dielectric sheet 61, for example, a copper foil pasted on a polyester film. The antenna 60 includes a feed element 62 and parasitic elements 63 and 64, as in the antenna 5 shown in FIG. 3.

The feed element 62 includes feed radiation electrodes 66 and 67 formed by dividing a common radiation electrode 65 and a feed terminal electrode 68 connected to the common radiation electrode 65. The feed radiation electrode 66 has a slit 69 at the center thereof and the feed radiation electrode 66 has an effective line length so that the feed radiation electrode 66 resonates at a frequency lower than that of the feed radiation electrode 67.

The parasitic elements 63 and 64 are placed on both sides of the feed element 62. The parasitic element 63 on the side of the feed radiation electrode 66 includes a parasitic radiation electrode 70 and a ground terminal electrode 71. The parasitic radiation electrode 70 has a slit 72. Also, a ground electrode 73 is placed on the side of an open end of the parasitic radiation electrode 70. The parasitic element 63 resonates at a frequency that is approximately equal to the resonance frequency on the side of the feed radiation electrode 66 of the feed element 62 and at a frequency of a harmonic resonance that is approximately equal to the resonance frequency on the side of the feed radiation electrode 67, as in the parasitic element 7 shown in FIG. 3.

Also, the parasitic element 64 includes a parasitic radiation electrode 74 and a ground terminal electrode 75. The parasitic element 64 resonates at a frequency approximate to the resonance frequency on the side of the feed radiation electrode 67 of the feed element 62. In the dielectric sheet 61, slits 76 are formed on both sides of the feed terminal electrode 68 and on one side of the ground electrode 73. When the antenna 60 is set, the positions of the feed terminal electrode 68 and the ground terminal electrodes 71 and 75 can be changed.

The above-described antenna 60 is set, for example, by attaching it to the bottom wall 30 of the casing 3. Further, the feed terminal electrode 68 of the feed element 62 is connected to the feed contact land 34 of the circuit board 4, the ground terminal electrodes 71 and 75 of the parasitic elements 63 and 64 are connected to the ground contact lands 35 and 36, and the ground electrode 73 is connected to the ground contact land 37. When signal power is supplied from the high-frequency circuit to the feed element 62, the antenna 60 operates in the same manner as the antenna 5 shown in FIG. 3.

While preferred embodiments of the invention have been described above, it is to be understood that variations and modifications will be apparent to those skilled in the art without departing the scope and spirit of the invention. The scope of the invention, therefore, is to be determined solely by the following claims.

What is claimed is:

1. A wireless communication apparatus comprising:
a circuit board having a high-frequency circuit disposed therein;
a casing accommodating the circuit board; and
an antenna disposed inside the casing or on a surface of the casing, the antenna including:
a feed element having at least one feed radiation plate and a feed terminal plate connecting the feed radiation plate to the high-frequency circuit; and
at least one parasitic element having a parasitic radiation plate located adjacent to and along the feed radiation plate of the feed element and a ground terminal plate connecting the parasitic radiation plate to a ground surface of the circuit board.

2. The wireless communication apparatus according to claim 1, wherein the end of the feed radiation plate opposite to the side of the feed terminal plate is an open end, the end of the parasitic radiation plate opposite to the side of the ground terminal plate is an open end, a capacitance loading plate is disposed at at least one of the open ends, and a ground plate which is fixed to the casing and which faces the capacitance loading plate is provided.

3. The wireless communication apparatus according to claim 1, wherein the antenna is incorporated into the casing.

4. The wireless communication apparatus according to claim 1, wherein the antenna is disposed on an inner wall of the casing.

5. The wireless communication apparatus according to claim 1, wherein a portion or all of at least one of the feed element and the parasitic element is embedded in the casing, except a feed contact terminal disposed in the feed element and a ground contact terminal disposed in the parasitic element.

6. The wireless communication apparatus according to claim 1, wherein the relative permittivity of the casing is used to adjust the coupling relationship between the feed element and the parasitic element.

7. The wireless communication apparatus according to claim 1, wherein at least an antenna setting portion of the casing is molded of a composite dielectric material.

8. The wireless communication apparatus according to claim 1, wherein a portion of the casing in which the feed element and the parasitic element are disposed or a portion along the adjacent edges of the feed radiation plate of the feed element and the parasitic radiation plate of the parasitic element is made of a dielectric material having a relative permittivity which is higher than that of the casing.

9. The wireless communication apparatus according to claim 4, wherein a dielectric member having a relative permittivity which is higher than that of the casing is disposed between the inner wall of the casing, the feed radiation plate of the feed element, and the parasitic radiation plate of the parasitic element.

10. The wireless communication apparatus according to claim 1, wherein the feed contact terminal and the ground contact terminal are resilient, the resilient feed contact terminal is provided in the feed radiation plate, and the resilient ground contact terminal is provided in the parasitic radiation plate.

11. The wireless communication apparatus according to claim 1, wherein the casing includes a first casing and a second casing, the circuit board provided with a feed contact land and a ground contact land is placed in the first casing, the antenna including the feed contact terminal and the ground contact terminal is placed in the second casing, whereby the feed contact terminal contacts the feed contact land so as to be energized and the ground contact terminal contacts the ground contact land so as to be energized when the first and second casings are combined.

12. The wireless communication apparatus according to claim 1, wherein wireless communication apparatus is a mobile phone.

13. The wireless communication apparatus according to claim 1, wherein the feed element includes first and second feed radiation plates formed by dividing a common radiation plate by a slit and a feed terminal plate which is substantially perpendicular to the common radiation plate.

14. The wireless communication apparatus according to claim 1, wherein the at least one parasitic element includes a parasitic radiation plate, a strip-like ground terminal plate provided at one end in the longitudinal direction of the parasitic radiation plate, the ground terminal plate being substantially perpendicular to the parasitic radiation plate, and a capacitance loading plate which is substantially perpendicular to the parasitic radiation plate and which extends in the same direction as the ground terminal plate.

15. The wireless communication apparatus according to claim 1, wherein the at least one feed radiation plates and the parasitic radiation plate are arranged so as to be exposed at the surface of a bottom wall of the casing.

16. The wireless communication apparatus according to claim 1, wherein the feed terminal plate and the ground terminal plate are embedded in a shorter side wall of the casing.

17. The wireless communication apparatus according to claim 1, wherein the feed element and the parasitic element are excited by electric-field-coupling via a capacitance generated between the parasitic radiation plate and the at least one feed radiation plate and by magnetic-field-coupling between the ground terminal plate and the feed terminal plate.

18. The wireless communication apparatus according to claim 1, wherein the feed element and the parasitic element are excited by electric-field-coupling via the capacitance generated between the parasitic radiation plate and the at least one feed radiation plate and by magnetic-field-coupling between the ground terminal plate and the feed terminal plate.

19. The wireless communication apparatus according to claim 2, wherein edges of the capacitance loading plate and the ground plate provided in the parasitic radiation plate face each other.

20. The wireless communication apparatus according to claim 2, wherein the capacitance loading plate and the ground plate are arranged so that side surfaces thereof face each other.
